(19) United States
(12) Patent Application Publication
(10) Pub. No.: US 2026/0106786 A1
(43) Pub. Date: Apr. 16, 2026

(54) POSITIONING IN O-RAN ENVIRONMENTS

(71) Applicant: QUALCOMM Incorporated, San Diego, CA (US)

(72) Inventors: Mohamad SAYED HASSAN, Paris (FR); Sony AKKARAKARAN, Poway, CA (US); Alexandros MANOLAKOS, Athens (GR); Srinivas YERRAMALLI, San Diego, CA (US)

(21) Appl. No.: 19/114,755

(22) PCT Filed: Oct. 23, 2023
(86) PCT No.: PCT/US2023/035727

§ 371 Date: Mar. 24, 2025

(30) Foreign Application Priority Data
Nov. 9, 2022 (GR) 20220100917

(51) Int. Cl. H04L 27/26; H04L 5/00; H04W 64/00

(52) U.S. Cl. CPC H04L 27/2665; H04L 5/0048; H04L 27/2666; H04W 64/00

(57) ABSTRACT

Aspects presented herein relate to methods and devices for wireless communication including an apparatus, e.g., a network entity. The apparatus may obtain a configuration of a control plane including a set of time offsets. The apparatus may also calculate a corresponding fast Fourier transform (FFT) window for each time offset in the set of time offsets. The apparatus may also receive at least one reference signal (RS) during the corresponding FFT window for each time offset in the set of time offsets.

### CROSS-REFERENCE TO RELATED APPLICATION

This application claims the benefit of Greece Patent Application Serial No. 20220100917, entitled “POSITIONING IN O-RAN ENVIRONMENTS” and filed on Nov. 9, 2022, which is expressly incorporated by reference herein in its entirety.

### TECHNICAL FIELD

The present disclosure relates generally to communication systems, and more particularly, to positioning measurements in wireless communication systems.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be an apparatus for wireless communication at a network entity (e.g., a radio unit (RU) or a distributed unit (DU) in a radio access network (RAN)). The apparatus may obtain a configuration of a control plane including a set of time offsets. The apparatus may also select a set of subpanels or a set of transmission-reception (Tx-Rx) streams for at least one reference signal (RS) based on the configuration of the control plane. The apparatus may also apply each time offset in the set of time offsets to a corresponding fast Fourier transform (FFT) window. Additionally, the apparatus may determine a starting point of the corresponding FFT window based on each applied time offset. The apparatus may also calculate a corresponding fast Fourier transform (FFT) window for each time offset in the set of time offsets. The apparatus may also receive at least one reference signal (RS) during the corresponding FFT window for each time offset in the set of time offsets. Also, the apparatus may process the at least one RS after the corresponding FFT window for each time offset in the set of time offsets. The apparatus may also transmit the at least one RS based on processing the at least one RS after the corresponding FFT window.

In an aspect of the disclosure, a method, a computer-readable medium, and an apparatus are provided. The apparatus may be an apparatus for wireless communication at a network entity (e.g., a radio unit (RU) or a distributed unit (DU) in a radio access network (RAN)). The apparatus may configure a control plane including a set of time offsets. The apparatus may also transmit a configuration of the control plane including the set of time offsets, where each time offset in the set of time offsets is associated with a corresponding fast Fourier transform (FFT) window.

The apparatus may also receive at least one reference signal (RS) after the corresponding FFT window for each time offset in the set of time offsets. Moreover, the apparatus may process the at least one RS based on receiving the at least one RS after the corresponding FFT window for each time offset in the set of time offsets.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of a wireless communication system.

FIG. 6 is a diagram illustrating an example positioning procedure.

FIG. 7 is a diagram illustrating an example open radio access network (O-RAN) structure.

FIG. 8 is a diagram illustrating an example timing structure.

FIG. 9 is a diagram illustrating an example timing scheme.

FIG. 10 is a diagram illustrating an example timing extension for a message.

FIG. 11 is a communication flow diagram illustrating example communications between a network entity and a network entity.

FIG. 12 is a flowchart of a method of wireless communication.

FIG. 13 is a flowchart of a method of wireless communication.

FIG. 14 is a flowchart of a method of wireless communication.

FIG. 15 is a flowchart of a method of wireless communication.

FIG. 16 is a diagram illustrating an example of a hardware implementation for an example network entity.

FIG. 17 is a diagram illustrating an example of a hardware implementation for an example network entity.

### DETAILED DESCRIPTION

Some aspects of wireless communication may utilize a radio access network (RAN) as part of a mobile telecommunication system. A RAN may implement a radio access technology for the telecommunication system. Further, a RAN may provide access to and coordinate the management of resources across the radio sites in the telecommunication system. Some aspects of wireless communication may utilize positioning location functions. There may be a number of different positioning features that are enabled at the UE side and the network side. For example, positioning features enabled at the network side may include at least one of the following feature: uplink (UL) time difference of arrival (UL-TDoA), UL angle of arrival (UL-AoA), or round-trip time (RTT). These features may be based on an UL reference signal reception (e.g., a sounding reference signal (SRS)). These positioning features may also be enabled for layer 1 (L1)/layer 2 (L2) mobility. Further, there may be a number of sensing features that are supported by the network side. Uplink frequency domain (FD) samples of sounding reference signals (SRSs) may be sent based on the following configurations: fast Fourier transform (FFT) size, cyclic prefix (CP) length, sub-carrier spacing (SCS), and/or a time offset (e.g., if a section Type 3 message is used, otherwise the earliest in-phase and quadrature (IQ) time division (TD) samples may be pointed by a symbol identifier (ID). In some aspects, certain features (e.g., UL TDoA, UL AoA, and/or RTT) may be based on SRS FD IQ samples. For instance, in UL TDoA, for each SRS pilot, a network entity may compute the time offset based on SRS channel estimates (e.g., by computing the channel impulse response and detecting the strongest time offset associated with a strongest path or first path). Also, the UL TDoA may utilize a certain number of observations (e.g., M observations) of SRS FD IQ samples to be provided per SRS symbol and per reception point. Each observation may be associated with a different time offset (timeOffset). In some instances, a control user synchronization (CUS) specification may not support a control plane (C-plane) message with a certain number of time offset (timeOffset) parameters (e.g., M timeOffset parameters). To support UL TDoA at a network entity with some CUS specifications, M C-plane messages may be utilized which cause a fronthaul (FH) overhead. Accordingly, it may be beneficial to include a solution without C-plane overhead. In some aspects, similar to UL TDoA, some types of positioning features (e.g., UL AoA, RTT) may be based on SRS FD IQ samples. Also, these types of positioning features (e.g., UL AoA, RTT) may utilize a certain amount of observations (e.g., M observations) of SRS for neighbor cells and non-serving transmission-reception points (TRPs). For example, one SRS observation may be referring to SRS IQ samples to be transferred from the radio unit (RU) to the distributed unit (DU) with a given FFT size, timeOffset, SCS, and/or CP length. Also, in some aspects, when a UE moves from a source cell (e.g., the timing at the UE is adjusted with respect to source cell) to target cell within the configured cell set for L1/L2 mobility, the timing at the target cell may need to be adjusted and different time offsets may be utilized to enhance the timing adjustment when a UE starts to communicate data with the target cell. Thus, a certain amount of observations (e.g., M observations) may be utilized for UL reference signals and/or SRS. Also, the sensing features may need to have different observations to have accurate sensing. However, a CUS specification may not support a C-plane message with M time offset parameters. In order to support UL positioning features for a DU, L1/L2 mobility, and sensing, a certain number of C-plane messages (e.g., M C-plane messages) may be utilized. However, these C-plane messages may cause a fronthaul (FH) overhead. Aspects of the present disclosure may allow for UL positioning features without certain overhead (e.g., FH overhead). For example, aspects presented herein may utilize a certain number of C-plane messages (e.g., M C-plane messages). In some instances, this amount of C-plane messages may support UL positioning features without adding certain overhead (e.g., FH overhead). That is, aspects presented herein may support UL positioning features in a network environment without adding overhead, such as L1/L2 mobility features and/or sensing features. Additionally, aspects presented herein may allow for the transmission and/or reception of C-plane messages between certain network entities (e.g., an RU and/or a DU). Also, aspects presented herein may support control plane messages that include an adjustment or extension to the structure of the message (e.g., a section extension associated with a time offset structure).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

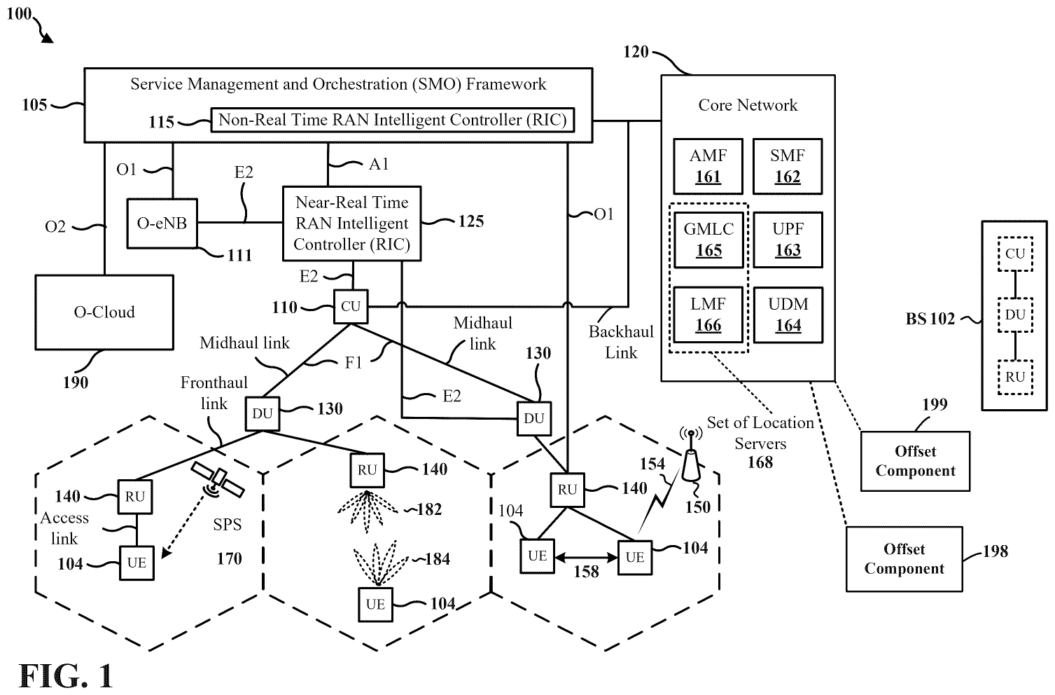

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and a velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network. In some scenarios, the term UE may also apply to one or more companion devices such as in a device constellation arrangement. One or more of these devices may collectively access the network and/or individually access the network. A network node can be implemented as a base station (i.e., an aggregated base station), as a disaggregated base station, an integrated access and backhaul (IAB) node, a relay node, a sidelink node, etc. A network entity can be implemented as a base station (i.e., an aggregated base station), or alternatively, as a central unit (CU), a distributed unit (DU), a radio unit (RU), a Near-Real Time (Near-RT) RAN Intelligent Controller (RIC), or a Non-Real Time (Non-RT) RIC in a disaggregated base station architecture.

Referring again to FIG. 1, in certain aspects, the base station 102, the core network 120, the DU 130, or the RU 140 may include an offset component 198 that may be configured to obtain a configuration of a control plane including a set of time offsets. Offset component 198 may also be configured to select a set of subpanels or a set of transmission-reception (Tx-Rx) streams for at least one reference signal (RS) based on the configuration of the control plane. Offset component 198 may also be configured to apply each time offset in the set of time offsets to a corresponding fast Fourier transform (FFT) window. Offset component 198 may also be configured to determine a starting point of the corresponding FFT window based on each applied time offset. Offset component 198 may also be configured to calculate a corresponding fast Fourier transform (FFT) window for each time offset in the set of time offsets. Offset component 198 may also be configured to receive at least one reference signal (RS) during the corresponding FFT window for each time offset in the set of time offsets. Offset component 198 may also be configured to process the at least one RS after the corresponding FFT window for each time offset in the set of time offsets. Offset component 198 may also be configured to transmit the at least one RS based on processing the at least one RS after the corresponding FFT window.

In certain aspects, the base station 102, the core network 120, the DU 130, or the RU 140 may include an offset component 199 that may be configured to configure a control plane including a set of time offsets. Offset component 199 may also be configured to transmit a configuration of the control plane including the set of time offsets, where each time offset in the set of time offsets is associated with a corresponding fast Fourier transform (FFT) window. Offset component 199 may also be configured to receive at least one reference signal (RS) after the corresponding FFT window for each time offset in the set of time offsets. Offset component 199 may also be configured to process the at least one RS based on receiving the at least one RS after the corresponding FFT window for each time offset in the set of time offsets. Although the following description may be focused on 5G NR, the concepts described herein may be applicable to other similar areas, such as LTE, LTE-A, CDMA, GSM, and other wireless technologies.

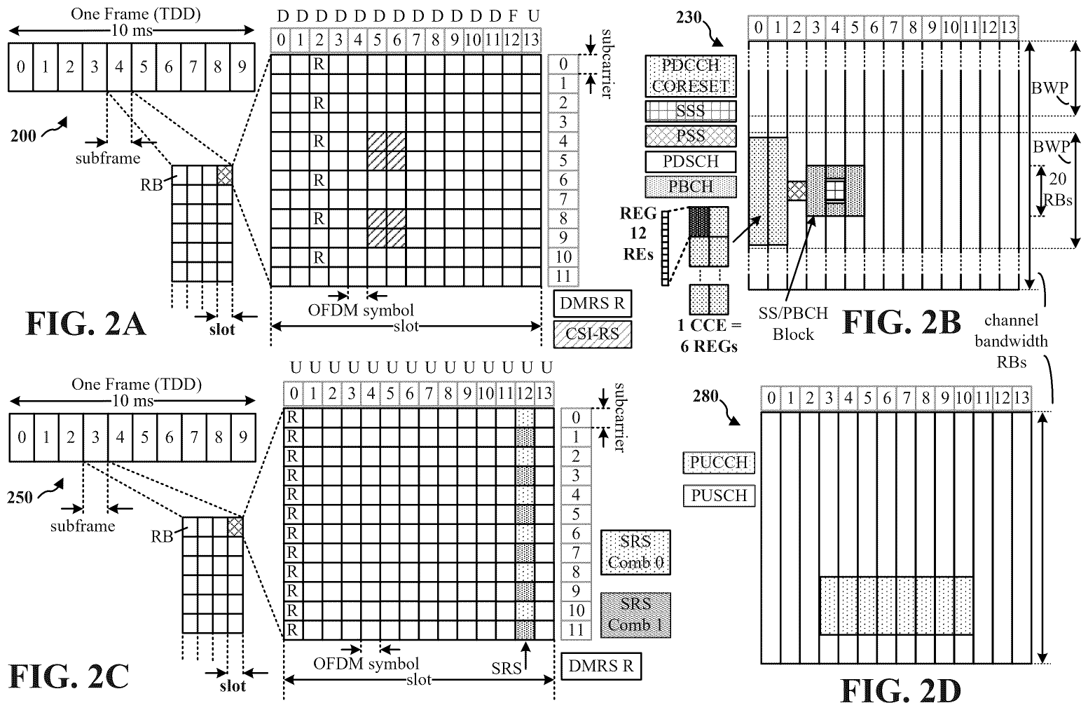

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

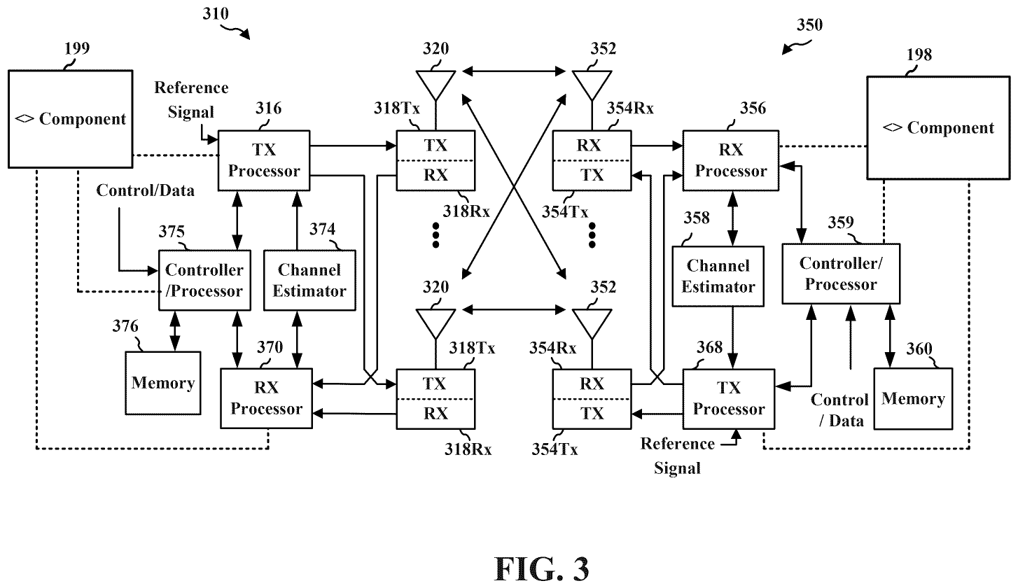

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the offset component 198 of FIG. 1. At least one of the TX processor 316, the RX processor 370, and the controller/processor 375 may be configured to perform aspects in connection with the offset component 199 of FIG. 1.

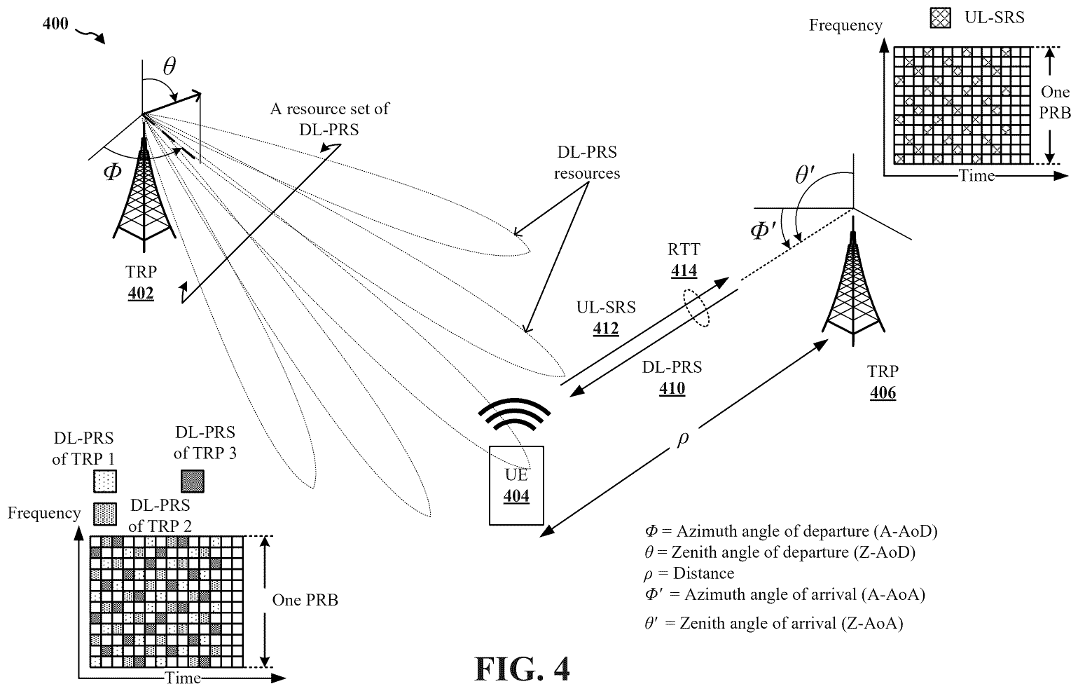

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406. DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404. UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AOD and/or DL-AoA. Note that data/measurements from various technologies may be combined in various ways to increase accuracy, to determine and/or to enhance certainty, to supplement/complement measurements, and/or to substitute/provide for missing information.

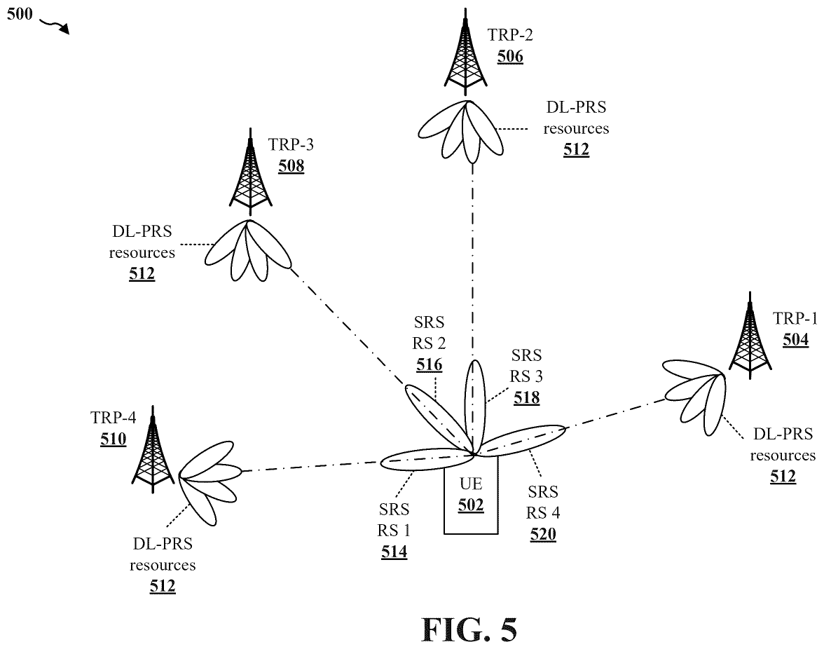

FIG. 5 is a diagram 500 illustrating an example of estimating a position of a UE based on multi-RTT measurements from multiple TRPs in accordance with various aspects of the present disclosure. A UE 502 may be configured by a serving base station to decode DL-PRS resources 512 that correspond to and are transmitted from a first TRP 504 (TRP-1), a second TRP 506 (TRP-2), a third TRP 508 (TRP-3), and a fourth TRP 510 (TRP-4). The UE 502 may also be configured to transmit UL-SRSs on a set of UL-SRS resources, which may include a first SRS resource 514, a second SRS resource 516, a third SRS resource 518, and a fourth SRS resource 520, such that the serving cell(s), e.g., the first TRP 504, the second TRP 506, the third TRP 508, and the fourth TRP 510, and as well as other neighbor cell(s), may be able to measure the set of the UL-SRS resources transmitted from the UE 502. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

In some aspects of wireless communication, the terms “positioning reference signal” and “PRS” may generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. In some aspects, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

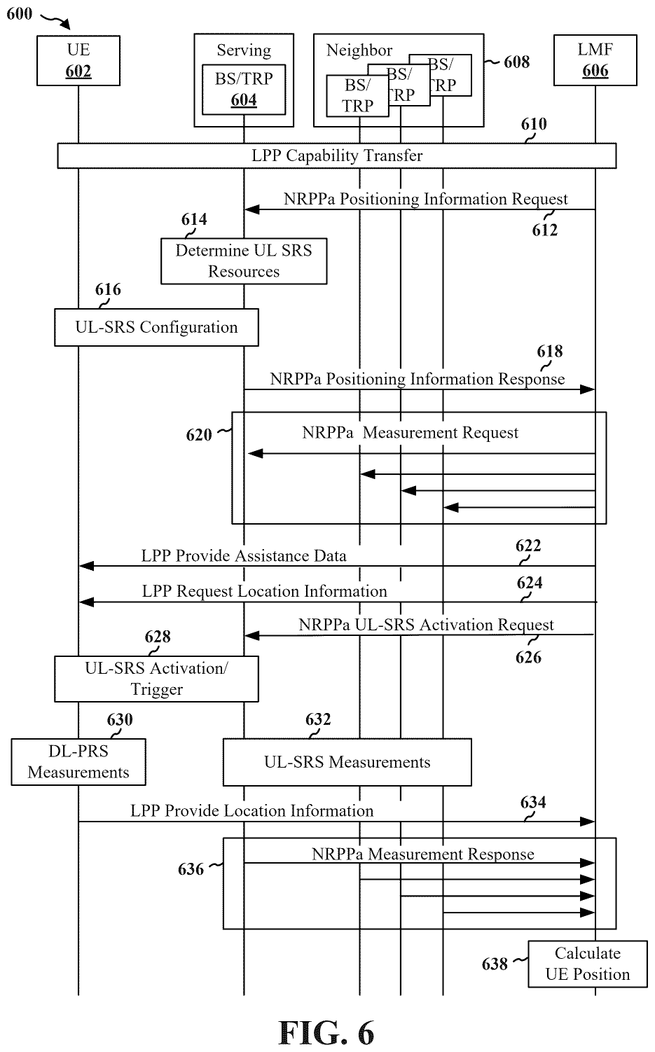

FIG. 6 is a communication flow 600 illustrating an example multi-RTT positioning procedure in accordance with various aspects of the present disclosure. The numberings associated with the communication flow 600 do not specify a particular temporal order and are merely used as references for the communication flow 600. In addition, a DL-only and/or an UL-only positioning may use a subset or subsets of this multi-RTT positioning procedure.

At 610, an LMF 606 may request one or more positioning capabilities from a UE 602 (e.g., from a target device). In some examples, the request for the one or more positioning capabilities from the UE 602 may be associated with an LTE Positioning Protocol (LPP). For example, the LMF 606 may request the positioning capabilities of the UE 602 using an LPP capability transfer procedure. At 612, the LMF 606 may request UL SRS configuration information for the UE 602. The LMF 606 may also provide assistance data specified by a serving base station 604 (e.g., pathloss reference, spatial relation, and/or SSB configuration(s), etc.). For example, the LMF 606 may send an NR Positioning Protocol A (NRPPa) positioning information request message to the serving base station 604 to request UL information for the UE 602.

At 614, the serving base station 604 may determine resources available for UL SRS, and at 616, the serving base station 604 may configure the UE 602 with one or more UL SRS resource sets based on the available resources. At 618, the serving base station 604 may provide UL SRS configuration information to the LMF 606, such as via an NRPPa positioning information response message. At 620, the LMF 606 may select one or more candidate neighbor BSs/TRPs 608, and the LMF 606 may provide an UL SRS configuration to the one or more candidate neighbor BSs/TRPs 608 and/or the serving base station 604, such as via an NRPPa measurement request message. The message may include information for enabling the one or more candidate neighbor BSs/TRPs 608 and/or the serving base station to perform the UL measurements.

At 622, the LMF 606 may send an LPP provide assistance data message to the UE 602. The message may include specified assistance data for the UE 602 to perform the DL measurements. At 624, the LMF 606 may send an LPP request location information message to the UE 602 to request multi-RTT measurements. At 626, for semi-persistent or aperiodic UL SRS, the LMF 606 may request the serving base station 604 to activate/trigger the UL SRS in the UE 602. For example, the LMF 606 may request activation of UE SRS transmission by sending an NRPPa positioning activation request message to the serving base station 604.

At 628, the serving base station 604 may activate the UE SRS transmission and send an NRPPa positioning activation response message. In response, the UE 602 may begin the UL-SRS transmission according to the time domain behavior of UL SRS resource configuration. At 630, the UE 602 may perform the DL measurements from the one or more candidate neighbor BSs/TRPs 608 and/or the serving base station 604 provided in the assistance data. At 632, each of the configured one or more candidate neighbor BSs/TRPs 608 and/or the serving base station 604 may perform the UL measurements. At 634, the UE 602 may report the DL measurements to the LMF 606, such as via an LPP provide location information message. At 636, each of the one or more candidate neighbor BSs/TRPs 608 and/or the serving base station 604 may report the UL measurements to the LMF 606, such as via an NRPPa measurement response message. At 638, the LMF 606 may determine the RTTs from the UE 602 and BS/TRP Rx-Tx time difference measurements for each of the one or more candidate neighbor BSs/TRPs 608 and/or the serving base station 604 for which corresponding UL and DL measurements were provided at 634 and 636, and the LMF 606 may calculate the position of the UE 602.

Some aspects of wireless communication may utilize a radio access network (RAN) as part of a mobile telecommunication system. A RAN may implement a radio access technology for the telecommunication system. Further, a RAN may provide access to and coordinate the management of resources across the radio sites in the telecommunication system. The RAN may reside between a device (e.g., a user equipment (UE) or a mobile phone, a computer, or any remotely controlled machine and provides connection with its core network (CN)). The CN may provide coordination between different parts of the access network and also provide connectivity to the internet. The RAN may also include a transport network, which provides connectivity between the RAN and the CN. In some aspects of a RAN, the radio unit (RU) may process digital radio signals, as well as transmit, receive, and convert the signals for the RAN base station. Types of RANs may include an open radio access network (O-RAN), such as a network configuration sponsored by a O-RAN alliance. In some types of operator deployment for wireless communication, a RAN infrastructure may include an open distributed unit (O-DU) and an open radio unit (O-RU), such as a RAN infrastructure with O-DU/O-RU split compliant with O-RAN control user synchronization (CUS) specification.

Some aspects of wireless communication may utilize positioning location functions. There may be a number of different positioning features that are enabled at the UE side and the network side. For example, positioning features enabled at the network side may include at least one of the following feature: uplink (UL) time difference of arrival (UL-TDOA), UL angle of arrival (UL-AoA), or round-trip time (RTT). These features may be based on an UL reference signal reception (e.g., a sounding reference signal (SRS)). Further, there may be a number of sensing features that are supported by the network side.

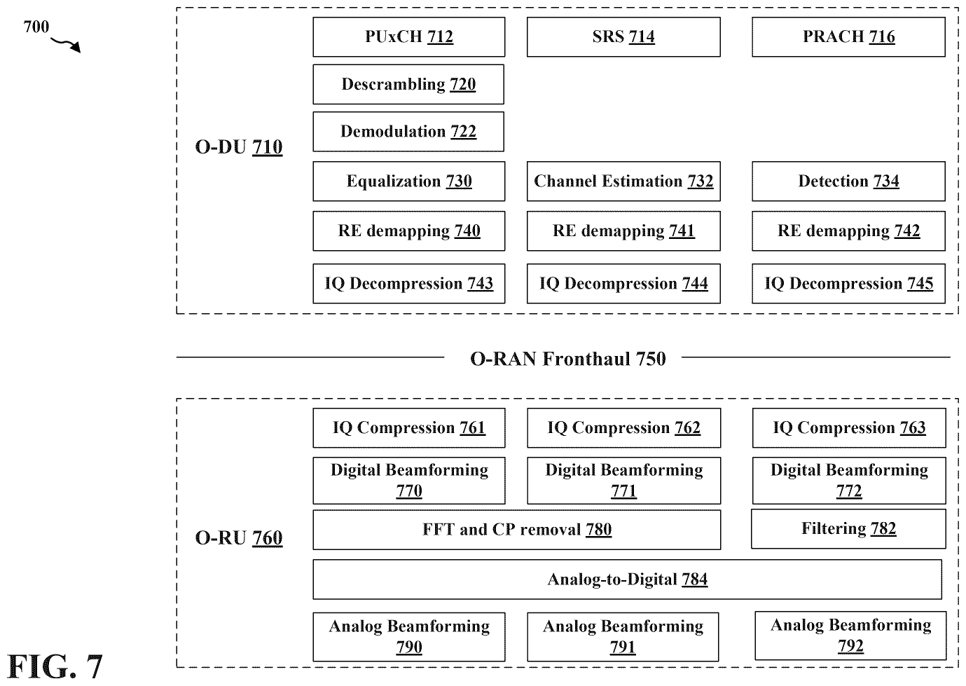

FIG. 7 is a diagram 700 illustrating an example open radio access network (O-RAN) structure. More specifically, FIG. 7 depicts an open distributed unit (O-DU) and an open radio unit (O-RU) in an O-RAN structure. As shown in FIG. 7, diagram 700 shows O-DU 710 including physical uplink channels (PUxCH) component 712, SRS component 714, PRACH component 716, descrambling component 720, demodulation component 722, equalization component 730, channel estimation component 732, detection component 734, resource element (RE) demapping component 740, RE demapping component 741, RE demapping component 742, in-phase and quadrature (IQ) decompression component 743, IQ decompression component 744, and IQ decompression component 745. Diagram 700 also depicts O-RAN fronthaul (FH) 750 and O-RU 760 including IQ compression component 761, IQ compression component 762, IQ compression component 763, digital beamforming component 770, digital beamforming component 771, digital beamforming component 772, fast Fourier transform (FFT) and cyclic prefix (CP) removal component 780, filtering component 782, analog-to-digital component 784, analog beamforming component 790, analog beamforming component 791, and analog beamforming component 792.

As shown in FIG. 7, the O-RAN UL split may define the split between layer 1 (L1) L1-high at the DU side (e.g., O-DU 710) and L1-low at the RU side (e.g., O-RU 760). Additionally, information may be exchanged between the DU side (e.g., O-DU 710) and the RU side (e.g., O-RU 760) based on control plane (C-plane) messages, user plane (U-plane) messages, and/or synchronization plane (S-plane) messages. Further, the O-RU (e.g., O-RU 760) may send UL frequency domain (FD) samples of certain RSs (e.g., SRS) to the O-DU (e.g., O-DU 710) based on a number of different configurations. For example, UL FD samples of SRSs may be sent based on the following configurations: FFT size, cyclic prefix (CP) length, sub-carrier spacing (SCS), and/or a time offset (e.g., if a section Type 3 message is used, otherwise the earliest IQ time division (TD) samples may be pointed by a symbol identifier (ID).

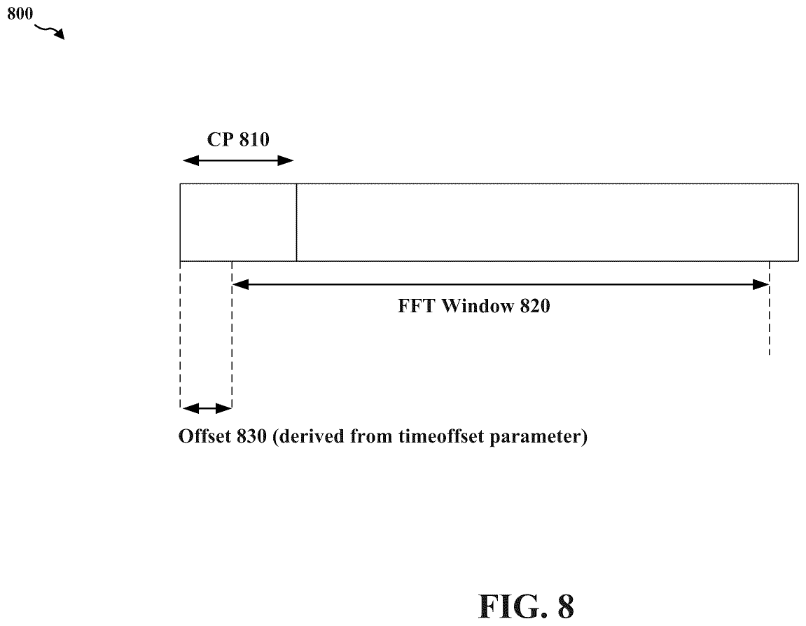

FIG. 8 is a diagram 800 illustrating an example timing structure. More specifically, FIG. 8 depicts a timing structure for an UL FD timing sample. As shown in FIG. 8, diagram 800 includes cyclic prefix (CP) 810, FFT window 820 (e.g., an FFT timing window), and offset 830 (e.g., a timing offset derived from a time offset (timeOffset) parameter). For example, diagram 800 shows that UL FD samples of SRSs may be sent based on FFT size (e.g., FFT window 820), CP length (e.g., CP 810), and time offset (e.g., offset 830).

In some aspects, certain features (e.g., UL TDoA, UL AoA, and/or RTT) may be based on SRS FD IQ samples. For instance, in UL TDoA, for each SRS pilot, the O-DU may compute the time offset based on SRS channel estimates (e.g., by computing the channel impulse response and detecting the time offset associated with a strongest path or first path). Also, the UL TDoA may utilize a certain number of observations (e.g., N observations) of SRS FD IQ samples to be provided per SRS symbol and per reception point. Each observation may be associated with a different time offset (timeOffset). This may be important for non-serving TRPs or neighbor cells, such as if the timing is not adjusted for a neighbor cell. Indeed, the timing may be adjusted solely for serving TRPs. In some aspects, a transmission timing adjustment procedure may be used to adjust the timing of a UE with respect to a serving TRP. In some instances, a control user synchronization (CUS) specification may not support a C-plane message with a certain number of time offset (timeOffset) parameters (e.g., N timeOffset parameters). To support UL TDoA at O-DU with some CUS specifications, N C-plane messages may be utilized which cause a FH overhead. Accordingly, it may be beneficial to include a solution without C-plane overhead.

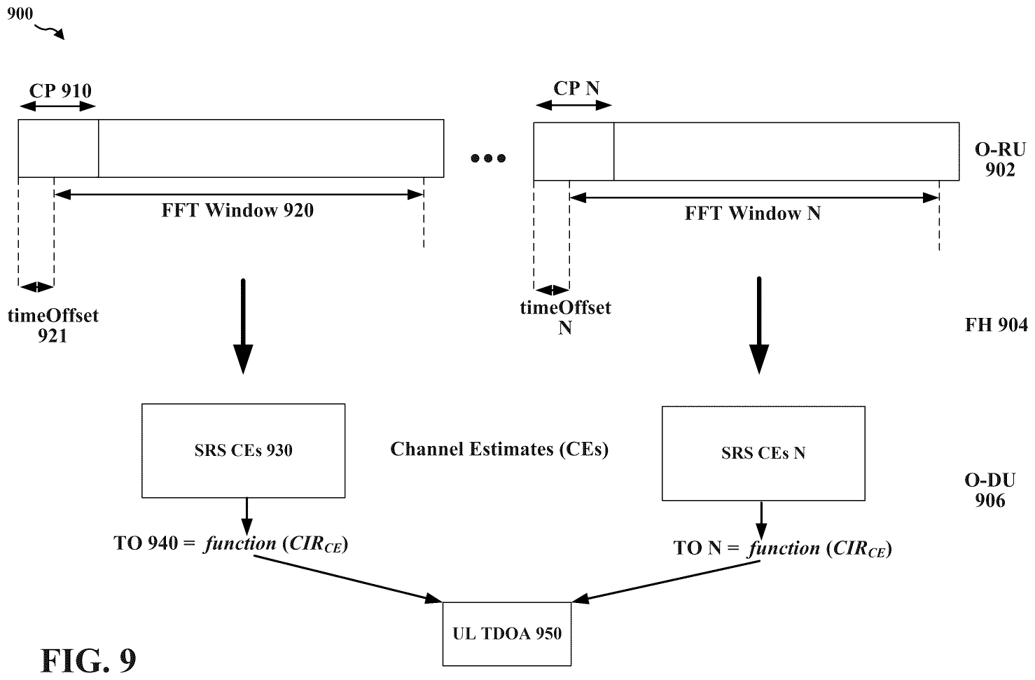

FIG. 9 is a diagram 900 illustrating an example timing scheme. More specifically, FIG. 9 depicts a timing scheme including timing structures for UL FD samples. As shown in FIG. 9, diagram 900 depicts O-RU 902 including cyclic prefix (CP) 910, FFT window 920 (e.g., an FFT timing window), and timeOffset 921 (e.g., a timing offset derived from a time offset (timeOffset) parameter). O-RU 902 also includes CP N, FFT window N, and timeOffset N (e.g., CP, FFT window, and timeOffset up to a certain amount, N). In some aspects, a CP window and an FFT window may be the same for different observations. That is, a CP of observation N and an FFT of observation N may be equal to a CP window and an FFT window of a first observation. For example, diagram 900 shows that UL FD samples of SRSs may be sent based on FFT size (e.g., FFT window 920), CP length (e.g., CP 910), and time offset (e.g., timeOffset 921). Diagram 900 also depicts fronthaul (FH) 904 and O-DU 906 including SRS channel estimates (CEs) 930, SRS CEs N (e.g., SRS CEs up to a certain value, N), time offset (TO) 940, time offset (TO) N, and UL TDOA 950. As shown in FIGS. 9, TO 940 and TO N are equal to a function of the channel impulse response (CIR) for the channel estimate (CE).

In some aspects, similar to UL TDoA, some types of positioning features (e.g., UL AoA, RTT) may be based on SRS FD IQ samples. Also, these types of positioning features (e.g., UL AoA, RTT) may utilize a certain amount of observations (e.g., N observations) of SRS for neighbor cells and non-serving TRPs. For example, one SRS observation may be referring to SRS IQ samples to be transferred from the O-RU to the O-DU with a given FFT size, timeOffset, SCS, and/or CP length. Also, in some aspects, when a UE moves from a source cell (e.g., the timing at the UE is adjusted with respect to source cell) to target cell within the configured cell set for L1/L2 mobility, the timing at the target cell may need to be adjusted and different time offsets may be utilized to enhance the timing adjustment when a UE starts to communicate data with the target cell. Thus, a certain amount of observations (e.g., N observations) may be utilized for UL reference signals, DMRS, and/or SRS. Also, the sensing features may need to have different observations to have accurate sensing. However, a CUS specification may not support a C-plane message with N time offset parameters. In order to support UL positioning features for an O-DU, L1/L2 mobility, and sensing, a certain number of C-plane messages (e.g., N C-plane messages) may be utilized. However, these C-plane messages may cause a fronthaul (FH) overhead. Based on the above, it may be beneficial to support UL positioning features without certain overhead (e.g., FH overhead). For instance, it may be beneficial to provide C-plane messages without causing a FH overhead.

Aspects of the present disclosure may allow for UL positioning features without certain overhead (e.g., FH overhead). For example, aspects presented herein may utilize a certain number of C-plane messages (e.g., N C-plane messages). In some instances, this amount of C-plane messages may support UL positioning features without adding certain overhead (e.g., FH overhead). That is, aspects presented herein may support UL positioning features in O-RAN environment without adding overhead, such as L1/L2 mobility features and/or sensing features. Additionally, aspects presented herein may allow for the transmission and/or reception of C-plane messages between certain network entities (e.g., an O-RU and/or an O-DU). Also, aspects presented herein may support control plane messages that include an adjustment or extension to the structure of the message (e.g., a section extension associated with a time offset structure).

Aspects presented herein may adjust or extend the structure of certain types of messages for supporting UL positioning features. For instance, aspects of the present disclosure may adjust or extend control plane (C-plane) messages in order to support UL positioning features. For example, aspects presented herein may add a section extension in a C-plane message in order to allow for a time offset (timeoffset or timeOffset) structure with a certain number of values (e.g., N values). Aspects of the present disclosure may also add a structure of a certain number of time offset fields (e.g., N-1 time offset fields) to the messages (e.g., C-plane messages). These added time offset fields may be in addition to the time offset fields that are already supported in control user synchronization (CUS) specifications. For example, if 1 time offset field is added to a C-plane message that already includes 1 time offset field, then N=2 (i.e., the previous C-plane message may correspond to N=1 in the CUS specification). Additionally, user plane (U-plane) traffic may be applied to receive the SRS frequency domain (FD) in-phase and quadrature (IQ) samples. That is, non-delay managed U-plane traffic may be applied to receive SRS FD samples at an O-DU or O-RU (e.g., if N SRS observations are utilized).

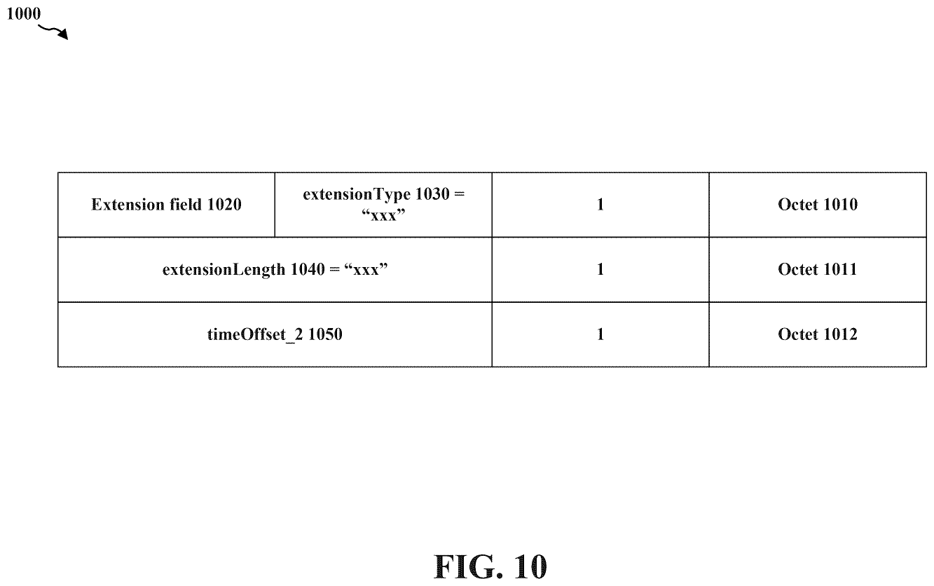

FIG. 10 is a diagram 1000 illustrating an example timing extension for a message. More specifically, FIG. 10 depicts an example timing extension for the structure of a control plane (C-plane) message. As shown in FIG. 10, diagram 1000 includes a number of octets (e.g., octet 1010, octet 1011, octet 1012), extension field 1020, and extension type (extensionType) 1030. Also, diagram 1000 includes extension length (extensionLength) 1040 and time offset (timeOffset_2_ 1050). For example, extension Type 1030 and extensionLength 1040 may be equal to a same value (e.g., “xxx”). As shown in FIG. 10, aspects presented herein may add time offset fields in a C-plane message in addition to the time offset fields that are already supported in CUS specifications. For example, as shown in FIG. 10, if aspects presented herein add 1 time offset field to a C-plane message that already includes 1 time offset field, then N=2 (i.e., the previous C-plane message may correspond to N=1 in the CUS specification). That is, aspects of the present disclosure may add 1 or more additional time offset fields to a current C-plane message format. As depicted in FIG. 10, a message for the control plane (e.g., a C-plane message) may include a section extension associated with a time offset structure. This section extension of the control plane message may the correspond to at least one of: a plurality of time offset fields, a plurality of values in the time offset structure, or a plurality of time offset parameters.

Additionally, aspects presented herein may reduce the amount of FH overhead that is utilized in sending UL RSs (e.g., SRSs). For instance, on top of non-delay managed U-plane traffic, in order to reduce the FH overhead of sending UL SRS at neighbor cells or non-serving transmission reception points (TRPs), aspects presented herein may receive energy-based or power-based solutions to be used by certain network entities (e.g., O-RU or O-DU). That is, aspects presented herein may receive energy-based or power-based solutions to be used at the O-RU or O-DU to select sub-panels or transmission-reception (Tx-Rx) streams with sufficient energy or power to reduce overhead. For example, one criterion may be that received power is above a configured threshold at the O-DU or the O-RU. Another criterion may be that received power is above the loading on the fronthaul (FH) interface. In some instances, an O-RU may select a set of subpanels or a set of transmission-reception (Tx-Rx) streams for a RS based on a configuration of the control plane. The configuration of the control plane may be received by the O-RU from the O-DU, where the configuration of the control plane includes at least one of: a maximum number of time offset fields, a maximum number of values in a time offset structure, or a maximum number of time offset parameters. Further, the selection of the set of subpanels or the set of Tx-Rx streams for the RS may include a selection of the set of subpanels or the set of Tx-Rx streams based on at least one power condition. As indicated above, the at least one power condition may correspond to a power threshold or a loading threshold of a fronthaul (FH) interface.

In some instances, the power measurement may be performed in the time domain before a corresponding FFT window. The streams that do not satisfy the aforementioned power criterion may be dropped. For example, streams may be dropped if they do not satisfy the received power is above a configured threshold or the loading on the FH interface. In some instances, if all streams do not satisfy the power criterion, the entire SRS symbol may be dropped (i.e., the symbol may not be transmitted from one network entity (e.g., the O-RU) to another network entity (e.g., the O-DU)). Further, there may be some indication to the O-DU (i.e., from the O-RU to the O-DU) if a specific SRS does not cross a threshold.

In some aspects, a network entity (e.g., O-DU) may define a maximum value (e.g., N value) that the network entity (e.g., O-DU) may indicate to another network entity (e.g., O-RU). In turn, the O-RU may determine, or use its own judgment regarding, the amount of different FFT offsets (e.g., offsets where L<N) for which it provides data. The amount of different FFT offsets may be determined as long as the amount is within a configured maximum number (e.g., maximum N). Also, this determination or judgment may be based on energy levels as described above. In some instances, a network entity (e.g., O-RU) may need to signal to another network entity (e.g., O-DU) the number of FFT offsets (e.g., “L” FFT offsets) that have been used from a total amount of configured FFT offsets (e.g., “N” configured FFT offsets).

Additionally, aspects of the present disclosure may include CUS specification-friendly solutions in order to support certain UL positioning features. For example, aspects presented herein may provide for CUS specification-friendly solutions to support L1/L2 mobility and/or sensing features in an O-RAN environment. Additionally, aspects presented herein may support RAN-compliant solutions for certain types of network or network entities, as well as support certain positioning features (e.g., UL positioning features), such as L1/L2 mobility and/or sensing features at the network. Aspects presented herein may accomplish these RAN-compliant solutions by adjusting or extending a structure of certain messages (e.g., C-plane messages).

As indicated herein, certain type of control plane, user plane, and synchronization plane (CUS plane) specifications may not support C-plane messages with certain types of time offset parameters (e.g., N time offset parameters). To support UL TDoA at certain network entities (e.g., O-DU and O-RU) with CUS specifications, aspects presented herein may support a certain amount of C-plane messages (e.g., N C-plane messages) which reduce and/or eliminate the FH overhead. Further, aspects presented herein may provide a solution without C-plane overhead. For instance, aspects of the present disclosure may add a section extension in C-plane messages indicating a time offset structure with a certain amount of values (e.g., N values). Additionally, aspects of the present disclosure may add a structure of a certain number of time offset fields (e.g., N-1 time offset fields) in addition to the time offset field already supported in CUS specification.

Aspects of the present disclosure may include a number of benefits or advantages. For instance, aspects presented herein may provide UL positioning features without certain overhead (e.g., FH overhead). For example, aspects presented herein may utilize a certain number of C-plane messages (e.g., N C-plane messages). In some aspects, a certain amount of C-plane messages may be added without adding certain overhead (e.g., FH overhead). For instance, aspects presented herein may support UL positioning features in O-RAN environments without adding overhead (e.g., L1/L2 mobility features and/or sensing features). Moreover, aspects presented herein may allow for the transmission and/or reception of C-plane messages between certain network entities (e.g., a O-RU and/or an O-DU). Additionally, aspects presented herein may provide control plane messages that include an adjustment or extension to the structure of the control plane message (e.g., a section extension associated with a time offset structure). The methods described herein may be applied to a number of different uplink (UL) signals or channels, such as UL signals or channels where multiple observations are utilized. For example, the methods described herein may be applied to UL DMRS signals. In some aspects, positioning location methods described herein may utilize UL DMRS with UL SRS and/or without UL SRS.

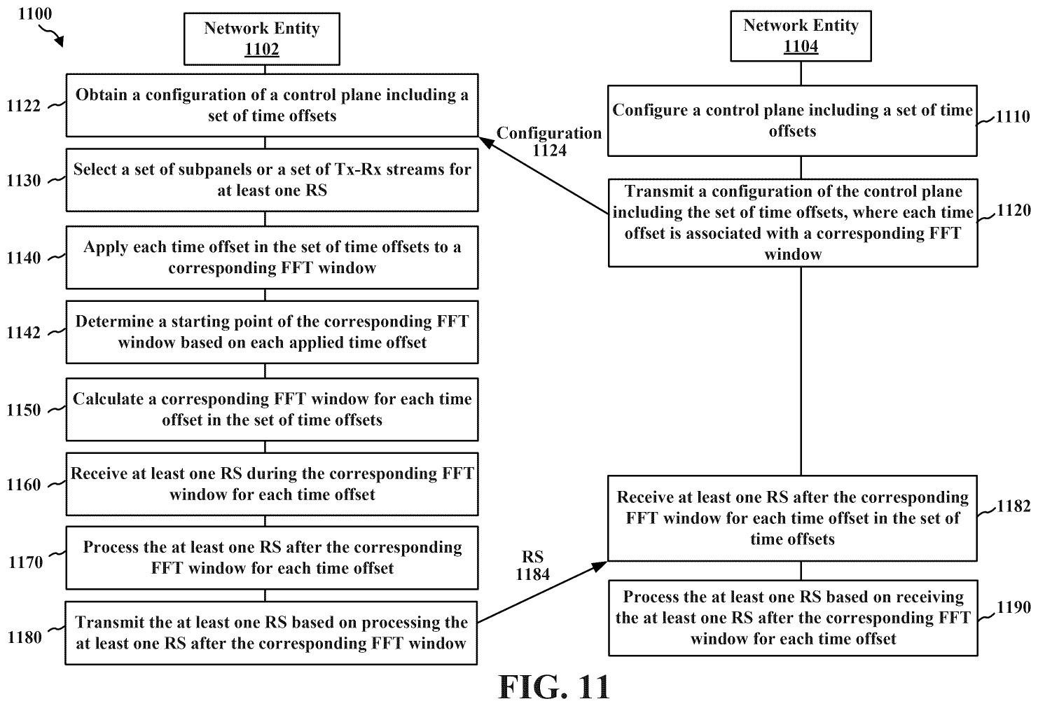

FIG. 11 is a communication flow diagram 1100 of wireless communication in accordance with one or more techniques of this disclosure. As shown in FIG. 11, diagram 1100 includes example communications between network entity 1102 (e.g., an RU or a DU) and a network entity 1104 (e.g., an RU or a DU), in accordance with one or more techniques of this disclosure. In some aspects, network entity 1102 may be a first wireless device (e.g., UE, base station, TRP, or network entity) and network entity 1104 may be a second wireless device (e.g., UE, base station, TRP, or network entity).

At 1110, network entity 1104 may configure a control plane including a set of time offsets.

At 1120, network entity 1104 may transmit a configuration of the control plane including the set of time offsets (e.g., configuration 1124), where each time offset in the set of time offsets is associated with a corresponding fast Fourier transform (FFT) window. In some aspects, each time offset in the set of time offsets may be applied to the corresponding FFT window. Also, a starting point of the corresponding FFT window may be based on each applied time offset in the set of time offsets. In some instances, the corresponding FFT window for each time offset may be associated with at least one message for the control plane. The at least one message for the control plane may include a section extension associated with a time offset structure. Also, the section extension of the at least one message for the control plane may correspond to at least one of: a plurality of time offset fields, a plurality of values in the time offset structure, or a plurality of time offset parameters. The configuration of the control plane may include at least one of: a maximum number of time offset fields, a maximum number of values in a time offset structure, or a maximum number of time offset parameters. The configuration of the control plane may be associated with an adjustment to the set of time offsets. Further, the configuration of the control plane may include at least one of: a frame structure, a cyclic prefix (CP) length, a starting physical resource block (PRB) in a set of PRBs, or a number of PRBs in the set of PRBs. Also, the corresponding FFT window for each time offset in the set of time offsets may be associated with an observation window. In some instances, the network entity may be a distributed unit (DU) in a radio access network (RAN). Also, transmitting the configuration of the control plane may include transmitting the configuration to a radio unit (RU) in the RAN.

At 1122, network entity 1102 may obtain a configuration of a control plane including a set of time offsets (e.g., configuration 1124). The configuration of the control plane may include at least one of: a maximum number of time offset fields, a maximum number of values in a time offset structure, or a maximum number of time offset parameters. Also, the configuration of the control plane may be associated with an adjustment to the set of time offsets. The configuration of the control plane may further include at least one of: a frame structure, a cyclic prefix (CP) length, a starting physical resource block (PRB) in a set of PRBs, or a number of PRBs in the set of PRBs. In some aspects, the network entity may be a radio unit (RU) in a radio access network (RAN). Further, obtaining the configuration of the control plane may include receiving the configuration of the control plane from a distributed unit (DU) in the RAN.

At 1130, network entity 1102 may select a set of subpanels or a set of transmission-reception (Tx-Rx) streams for at least one reference signal (RS) based on the configuration of the control plane. In some aspects, selecting the set of subpanels or the set of Tx-Rx streams for the at least one RS may include selecting the set of subpanels or the set of Tx-Rx streams based on at least one power condition. Also, the at least one power condition may correspond to a power threshold or a loading threshold of a fronthaul (FH) interface.

At 1140, network entity 1102 may apply each time offset in the set of time offsets to a corresponding fast Fourier transform (FFT) window. In some aspects, calculating the corresponding FFT window for each time offset may include calculating the corresponding FFT window for each applied time offset.

At 1142, network entity 1102 may determine a starting point of the corresponding FFT window based on each applied time offset. In some aspects, calculating the corresponding FFT window for each time offset may include calculating the corresponding FFT window for each time offset further based on the starting point of the corresponding FFT window.

At 1150, network entity 1102 may calculate a corresponding fast Fourier transform (FFT) window for each time offset in the set of time offsets. The corresponding FFT window for each time offset may be associated with at least one message for the control plane. The at least one message for the control plane may include a section extension associated with a time offset structure. The section extension of the at least one message for the control plane may correspond to at least one of: a plurality of time offset fields, a plurality of values in the time offset structure, or a plurality of time offset parameters. Also, the corresponding FFT window for each time offset in the set of time offsets may be associated with an observation window.

At 1160, network entity 1102 may receive at least one reference signal (RS) during the corresponding FFT window for each time offset in the set of time offsets. In some aspects, receiving the at least one RS during the corresponding FFT window for each time offset in the set of time offsets may include receiving the at least one RS during the corresponding FFT window from a user equipment (UE) or a transmission reception point (TRP).

At 1170, network entity 1102 may process the at least one RS after the corresponding FFT window for each time offset in the set of time offsets.

At 1180, network entity 1102 may transmit the at least one RS (e.g., RS 1184) based on processing the at least one RS after the corresponding FFT window. In some aspects, transmitting the at least one RS may include transmitting the at least one RS to a distributed unit (DU) in a radio access network (RAN).

At 1182, network entity 1104 may receive at least one reference signal (RS) (e.g., RS 1184) after the corresponding FFT window for each time offset in the set of time offsets. In some aspects, a set of subpanels or a set of transmission-reception (Tx-Rx) streams for the at least one RS may be based on the configuration of the control plane. Also, the set of subpanels or the set of Tx-Rx streams for the at least one RS may further be based on at least one power condition, where the at least one power condition corresponds to a power threshold or a loading threshold of a fronthaul (FH) interface. Further, receiving the at least one RS may include receiving the at least one RS from an RU in the RAN.

At 1190, network entity 1104 may process the at least one RS based on receiving the at least one RS after the corresponding FFT window for each time offset in the set of time offsets.

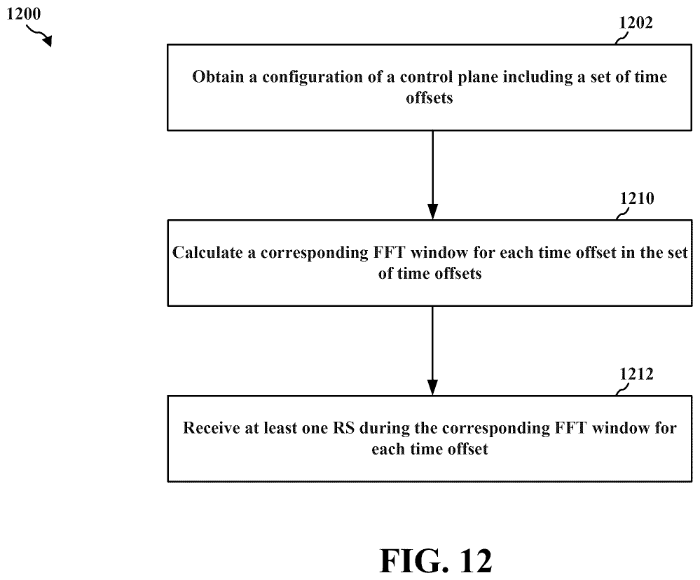

FIG. 12 is a flowchart 1200 of a method of wireless communication. The method may be performed by a network entity, an RU, a DU, or a base station (e.g., base station 102, network entity 1102; network entity 1602; network entity 1760). The methods described herein may provide a number of benefits, such as improving resource utilization and/or power savings.

At 1202, the network entity may obtain a configuration of a control plane including a set of time offsets, as discussed with respect to FIGS. 4-11. For example, as described in 1122 of FIG. 11, the network entity 1102 may obtain a configuration of a control plane including a set of time offsets. Further, step 1202 may be performed by offset component 198. The configuration of the control plane may include at least one of: a maximum number of time offset fields, a maximum number of values in a time offset structure, or a maximum number of time offset parameters. Also, the configuration of the control plane may be associated with an adjustment to the set of time offsets. The configuration of the control plane may further include at least one of: a frame structure, a cyclic prefix (CP) length, a starting physical resource block (PRB) in a set of PRBs, or a number of PRBs in the set of PRBs. In some aspects, the network entity may be a radio unit (RU) in a radio access network (RAN). Further, obtaining the configuration of the control plane may include receiving the configuration of the control plane from a distributed unit (DU) in the RAN.

At 1210, the network entity may calculate a corresponding fast Fourier transform (FFT) window for each time offset in the set of time offsets, as discussed with respect to FIGS. 4-11. For example, as described in 1150 of FIG. 11, the network entity 1102 may calculate a corresponding fast Fourier transform (FFT) window for each time offset in the set of time offsets. Further, step 1210 may be performed by offset component 198. The corresponding FFT window for each time offset may be associated with at least one message for the control plane. The at least one message for the control plane may include a section extension associated with a time offset structure. The section extension of the at least one message for the control plane may correspond to at least one of: a plurality of time offset fields, a plurality of values in the time offset structure, or a plurality of time offset parameters. Also, the corresponding FFT window for each time offset in the set of time offsets may be associated with an observation window.

At 1212, the network entity may receive at least one reference signal (RS) during the corresponding FFT window for each time offset in the set of time offsets, as discussed with respect to FIGS. 4-11. For example, as described in 1160 of FIG. 11, the network entity 1102 may receive at least one reference signal (RS) during the corresponding FFT window for each time offset in the set of time offsets. Further, step 1212 may be performed by offset component 198. In some aspects, receiving the at least one RS during the corresponding FFT window for each time offset in the set of time offsets may include receiving the at least one RS during the corresponding FFT window from a user equipment (UE) or a transmission reception point (TRP).

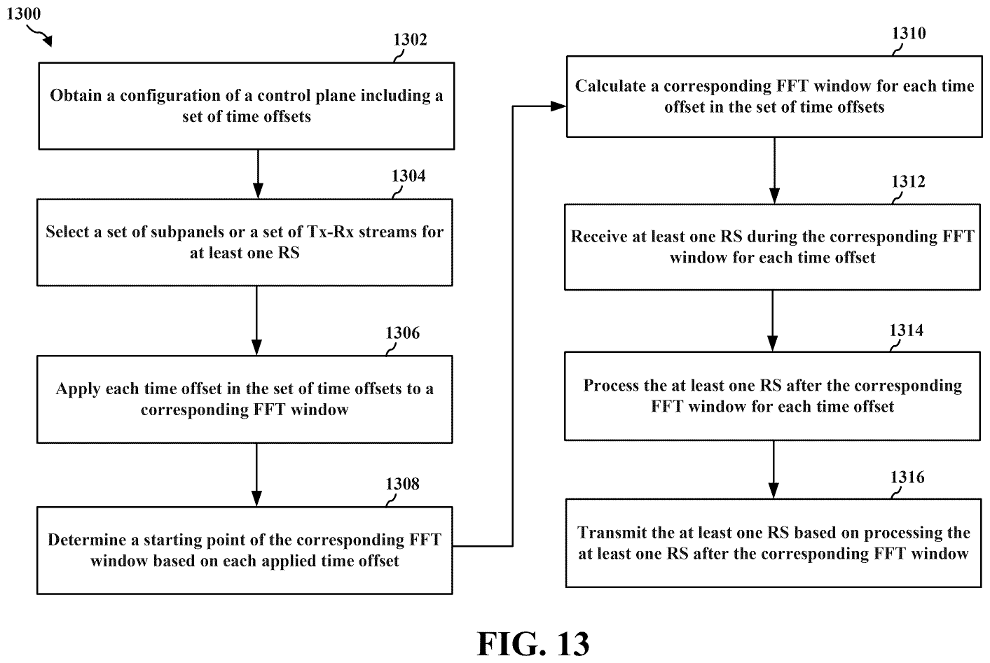

FIG. 13 is a flowchart 1300 of a method of wireless communication. The method may be performed by a network entity, an RU, a DU, or a base station (e.g., base station 102, network entity 1102; network entity 1602; network entity 1760). The methods described herein may provide a number of benefits, such as improving resource utilization and/or power savings.

At 1302, the network entity may obtain a configuration of a control plane including a set of time offsets, as discussed with respect to FIGS. 4-11. For example, as described in 1122 of FIG. 11, the network entity 1102 may obtain a configuration of a control plane including a set of time offsets. Further, step 1302 may be performed by offset component 198. The configuration of the control plane may include at least one of: a maximum number of time offset fields, a maximum number of values in a time offset structure, or a maximum number of time offset parameters. Also, the configuration of the control plane may be associated with an adjustment to the set of time offsets. The configuration of the control plane may further include at least one of: a frame structure, a cyclic prefix (CP) length, a starting physical resource block (PRB) in a set of PRBs, or a number of PRBs in the set of PRBs. In some aspects, the network entity may be a radio unit (RU) in a radio access network (RAN). Further, obtaining the configuration of the control plane may include receiving the configuration of the control plane from a distributed unit (DU) in the RAN.

At 1304, the network entity may select a set of subpanels or a set of transmission-reception (Tx-Rx) streams for at least one reference signal (RS) based on the configuration of the control plane, as discussed with respect to FIGS. 4-11. For example, as described in 1130 of FIG. 11, the network entity 1102 may select a set of subpanels or a set of transmission-reception (Tx-Rx) streams for at least one reference signal (RS) based on the configuration of the control plane. Further, step 1304 may be performed by offset component 198. In some aspects, selecting the set of subpanels or the set of Tx-Rx streams for the at least one RS may include selecting the set of subpanels or the set of Tx-Rx streams based on at least one power condition. Also, the at least one power condition may correspond to a power threshold or a loading threshold of a fronthaul (FH) interface.

At 1306, the network entity may apply each time offset in the set of time offsets to a corresponding fast Fourier transform (FFT) window, as discussed with respect to FIGS. 4-11. For example, as described in 1140 of FIG. 11, the network entity 1102 may apply each time offset in the set of time offsets to a corresponding fast Fourier transform (FFT) window. Further, step 1306 may be performed by offset component 198. In some aspects, calculating the corresponding FFT window for each time offset may include calculating the corresponding FFT window for each applied time offset.

At 1308, the network entity may determine a starting point of the corresponding FFT window based on each applied time offset, as discussed with respect to FIGS. 4-11. For example, as described in 1142 of FIG. 11, the network entity 1102 may determine a starting point of the corresponding FFT window based on each applied time offset. Further, step 1308 may be performed by offset component 198. In some aspects, calculating the corresponding FFT window for each time offset may include calculating the corresponding FFT window for each time offset further based on the starting point of the corresponding FFT window.

At 1310, the network entity may calculate a corresponding fast Fourier transform (FFT) window for each time offset in the set of time offsets, as discussed with respect to FIGS. 4-11. For example, as described in 1150 of FIG. 11, the network entity 1102 may calculate a corresponding fast Fourier transform (FFT) window for each time offset in the set of time offsets. Further, step 1310 may be performed by offset component 198. The corresponding FFT window for each time offset may be associated with at least one message for the control plane. The at least one message for the control plane may include a section extension associated with a time offset structure. The section extension of the at least one message for the control plane may correspond to at least one of: a plurality of time offset fields, a plurality of values in the time offset structure, or a plurality of time offset parameters. Also, the corresponding FFT window for each time offset in the set of time offsets may be associated with an observation window.

At 1312, the network entity may receive at least one reference signal (RS) during the corresponding FFT window for each time offset in the set of time offsets, as discussed with respect to FIGS. 4-11. For example, as described in 1160 of FIG. 11, the network entity 1102 may receive at least one reference signal (RS) during the corresponding FFT window for each time offset in the set of time offsets. Further, step 1312 may be performed by offset component 198. In some aspects, receiving the at least one RS during the corresponding FFT window for each time offset in the set of time offsets may include receiving the at least one RS during the corresponding FFT window from a user equipment (UE) or a transmission reception point (TRP).

At 1314, the network entity may process the at least one RS after the corresponding FFT window for each time offset in the set of time offsets, as discussed with respect to FIGS. 4-11. For example, as described in 1170 of FIG. 11, the network entity 1102 may process the at least one RS after the corresponding FFT window for each time offset in the set of time offsets. Further, step 1314 may be performed by offset component 198.

At 1316, the network entity may transmit the at least one RS based on processing the at least one RS after the corresponding FFT window, as discussed with respect to FIGS. 4-11. For example, as described in 1180 of FIG. 11, the network entity 1102 may transmit the at least one RS based on processing the at least one RS after the corresponding FFT window. Further, step 1316 may be performed by offset component 198. In some aspects, transmitting the at least one RS may include transmitting the at least one RS to a distributed unit (DU) in a radio access network (RAN).

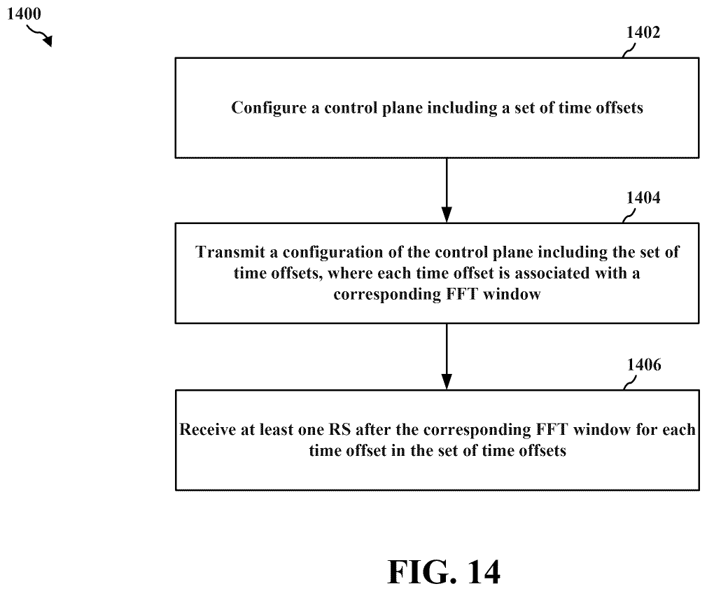

FIG. 14 is a flowchart 1400 of a method of wireless communication. The method may be performed by a network entity, an RU, a DU, or a base station (e.g., base station 102, network entity 1104; network entity 1602; network entity 1760). The methods described herein may provide a number of benefits, such as improving resource utilization and/or power savings.

At 1402, the network entity may configure a control plane including a set of time offsets, as discussed with respect to FIGS. 4-11. For example, as described in 1110 of FIG. 11, the network entity 1104 may configure a control plane including a set of time offsets. Further, step 1402 may be performed by offset component 199.

At 1404, the network entity may transmit a configuration of the control plane including the set of time offsets, where each time offset in the set of time offsets is associated with a corresponding fast Fourier transform (FFT) window, as discussed with respect to FIGS. 4-11. For example, as described in 1120 of FIG. 11, the network entity 1104 may transmit a configuration of the control plane including the set of time offsets, where each time offset in the set of time offsets is associated with a corresponding fast Fourier transform (FFT) window. Further, step 1404 may be performed by offset component 199. In some aspects, each time offset in the set of time offsets may be applied to the corresponding FFT window. Also, a starting point of the corresponding FFT window may be based on each applied time offset in the set of time offsets. In some instances, the corresponding FFT window for each time offset may be associated with at least one message for the control plane. The at least one message for the control plane may include a section extension associated with a time offset structure. Also, the section extension of the at least one message for the control plane may correspond to at least one of: a plurality of time offset fields, a plurality of values in the time offset structure, or a plurality of time offset parameters. The configuration of the control plane may include at least one of: a maximum number of time offset fields, a maximum number of values in a time offset structure, or a maximum number of time offset parameters. The configuration of the control plane may be associated with an adjustment to the set of time offsets. Further, the configuration of the control plane may include at least one of: a frame structure, a cyclic prefix (CP) length, a starting physical resource block (PRB) in a set of PRBs, or a number of PRBs in the set of PRBs. Also, the corresponding FFT window for each time offset in the set of time offsets may be associated with an observation window. In some instances, the network entity may be a distributed unit (DU) in a radio access network (RAN). Also, transmitting the configuration of the control plane may include transmitting the configuration to a radio unit (RU) in the RAN.

At 1406, the network entity may receive at least one reference signal (RS) after the corresponding FFT window for each time offset in the set of time offsets, as discussed with respect to FIGS. 4-11. For example, as described in 1182 of FIG. 11, the network entity 1104 may receive at least one reference signal (RS) after the corresponding FFT window for each time offset in the set of time offsets. Further, step 1406 may be performed by offset component 199. In some aspects, a set of subpanels or a set of transmission-reception (Tx-Rx) streams for the at least one RS may be based on the configuration of the control plane. Also, the set of subpanels or the set of Tx-Rx streams for the at least one RS may further be based on at least one power condition, where the at least one power condition corresponds to a power threshold or a loading threshold of a fronthaul (FH) interface. Further, receiving the at least one RS may include receiving the at least one RS from an RU in the RAN.

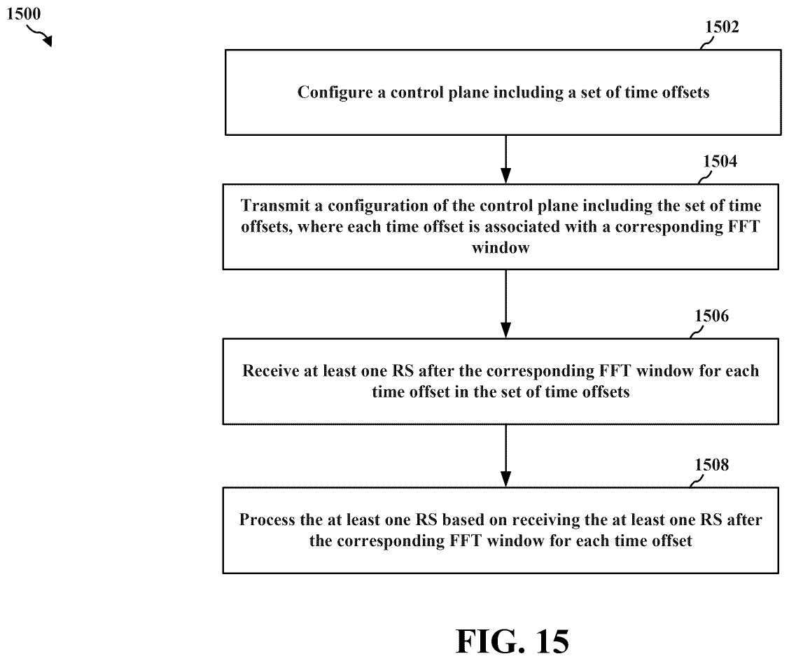

FIG. 15 is a flowchart 1500 of a method of wireless communication. The method may be performed by a network entity, an RU, a DU, or a base station (e.g., base station 102, network entity 1104; network entity 1602; network entity 1760). The methods described herein may provide a number of benefits, such as improving resource utilization and/or power savings.

At 1502, the network entity may configure a control plane including a set of time offsets, as discussed with respect to FIGS. 4-11. For example, as described in 1110 of FIG. 11, the network entity 1104 may configure a control plane including a set of time offsets. Further, step 1502 may be performed by offset component 199.

At 1504, the network entity may transmit a configuration of the control plane including the set of time offsets, where each time offset in the set of time offsets is associated with a corresponding fast Fourier transform (FFT) window, as discussed with respect to FIGS. 4-11. For example, as described in 1120 of FIG. 11, the network entity 1104 may transmit a configuration of the control plane including the set of time offsets, where each time offset in the set of time offsets is associated with a corresponding fast Fourier transform (FFT) window. Further, step 1504 may be performed by offset component 199. In some aspects, each time offset in the set of time offsets may be applied to the corresponding FFT window. Also, a starting point of the corresponding FFT window may be based on each applied time offset in the set of time offsets. In some instances, the corresponding FFT window for each time offset may be associated with at least one message for the control plane. The at least one message for the control plane may include a section extension associated with a time offset structure. Also, the section extension of the at least one message for the control plane may correspond to at least one of: a plurality of time offset fields, a plurality of values in the time offset structure, or a plurality of time offset parameters. The configuration of the control plane may include at least one of: a maximum number of time offset fields, a maximum number of values in a time offset structure, or a maximum number of time offset parameters. The configuration of the control plane may be associated with an adjustment to the set of time offsets. Further, the configuration of the control plane may include at least one of: a frame structure, a cyclic prefix (CP) length, a starting physical resource block (PRB) in a set of PRBs, or a number of PRBs in the set of PRBs. Also, the corresponding FFT window for each time offset in the set of time offsets may be associated with an observation window. In some instances, the network entity may be a distributed unit (DU) in a radio access network (RAN). Also, transmitting the configuration of the control plane may include transmitting the configuration to a radio unit (RU) in the RAN.

At 1506, the network entity may receive at least one reference signal (RS) after the corresponding FFT window for each time offset in the set of time offsets, as discussed with respect to FIGS. 4-11. For example, as described in 1182 of FIG. 11, the network entity 1104 may receive at least one reference signal (RS) after the corresponding FFT window for each time offset in the set of time offsets. Further, step 1506 may be performed by offset component 199. In some aspects, a set of subpanels or a set of transmission-reception (Tx-Rx) streams for the at least one RS may be based on the configuration of the control plane. Also, the set of subpanels or the set of Tx-Rx streams for the at least one RS may further be based on at least one power condition, where the at least one power condition corresponds to a power threshold or a loading threshold of a fronthaul (FH) interface. Further, receiving the at least one RS may include receiving the at least one RS from an RU in the RAN.

At 1508, the network entity may process the at least one RS based on receiving the at least one RS after the corresponding FFT window for each time offset in the set of time offsets, as discussed with respect to FIGS. 4-11. For example, as described in 1190 of FIG. 11, the network entity 1104 may process the at least one RS based on receiving the at least one RS after the corresponding FFT window for each time offset in the set of time offsets. Further, step 1508 may be performed by offset component 199.

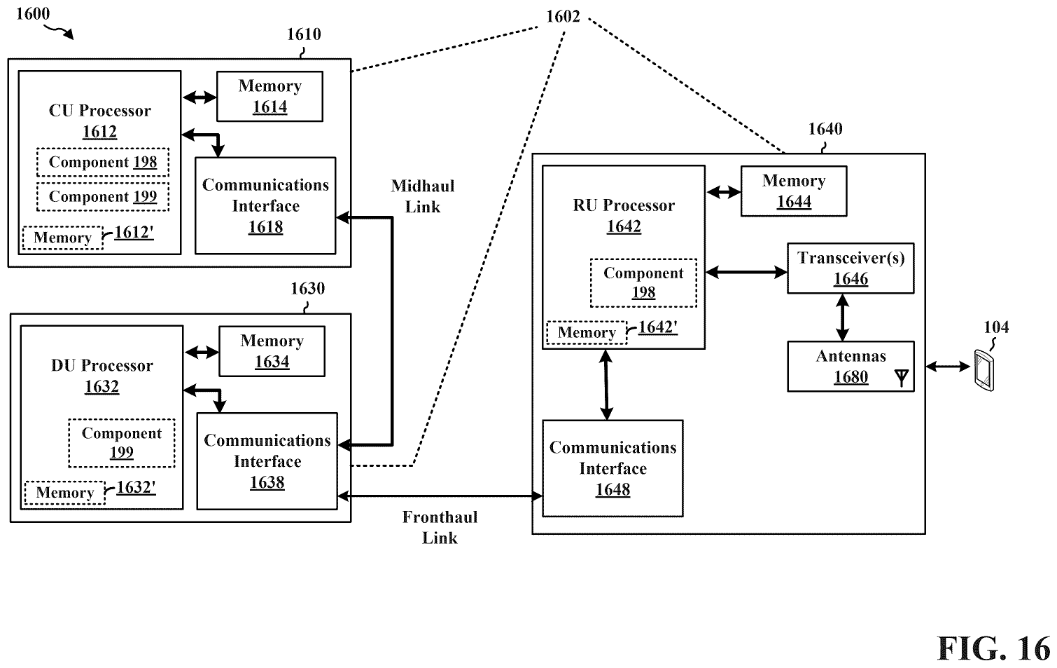

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the offset component 198 and the offset component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include additional memory modules 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the offset component 198 may be configured to obtain a configuration of a control plane including a set of time offsets. The offset component 198 may also be configured to calculate a corresponding fast Fourier transform (FFT) window for each time offset in the set of time offsets. The offset component 198 may also be configured to receive at least one reference signal (RS) during the corresponding FFT window for each time offset in the set of time offsets. The offset component 198 may also be configured to apply each time offset in the set of time offsets to the corresponding FFT window. The offset component 198 may also be configured to determine a starting point of the corresponding FFT window based on each applied time offset. The offset component 198 may also be configured to select a set of subpanels or a set of transmission-reception (Tx-Rx) streams for the at least one RS based on the configuration of the control plane. The offset component 198 may also be configured to process the at least one RS after the corresponding FFT window for each time offset in the set of time offsets. The offset component 198 may also be configured to transmit the at least one RS based on processing the at least one RS after the corresponding FFT window. The offset component 199 may also be configured to configure a control plane including a set of time offsets. The offset component 199 may also be configured to transmit a configuration of the control plane including the set of time offsets, where each time offset in the set of time offsets is associated with a corresponding fast Fourier transform (FFT) window. The offset component 199 may also be configured to receive at least one reference signal (RS) after the corresponding FFT window for each time offset in the set of time offsets. The offset component 199 may also be configured to process the at least one RS based on receiving the at least one RS after the corresponding FFT window for each time offset in the set of time offsets.

The offset component 198 and offset component 199 may be within one or more processors of one or more of the CU 1610, DU 1630, and the RU 1640. The offset component 198 and offset component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 may include means for obtaining a configuration of a control plane including a set of time offsets. The network entity 1602 may also include means for calculating a corresponding fast Fourier transform (FFT) window for each time offset in the set of time offsets. The network entity 1602 may also include means for receiving at least one reference signal (RS) during the corresponding FFT window for each time offset in the set of time offsets. The network entity 1602 may also include means for applying each time offset in the set of time offsets to the corresponding FFT window. The network entity 1602 may also include means for determining a starting point of the corresponding FFT window based on each applied time offset. The network entity 1602 may also include means for selecting a set of subpanels or a set of transmission-reception (Tx-Rx) streams for the at least one RS based on the configuration of the control plane. The network entity 1602 may also include means for processing the at least one RS after the corresponding FFT window for each time offset in the set of time offsets. The network entity 1602 may also include means for transmitting the at least one RS based on processing the at least one RS after the corresponding FFT window. The network entity 1602 may also include means for configuring a control plane including a set of time offsets. The network entity 1602 may also include means for transmitting a configuration of the control plane including the set of time offsets, where each time offset in the set of time offsets is associated with a corresponding fast Fourier transform (FFT) window. The network entity 1602 may also include means for receiving at least one reference signal (RS) after the corresponding FFT window for each time offset in the set of time offsets. The network entity 1602 may also include means for processing the at least one RS based on receiving the at least one RS after the corresponding FFT window for each time offset in the set of time offsets. The means may be the offset component 198 and the offset component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

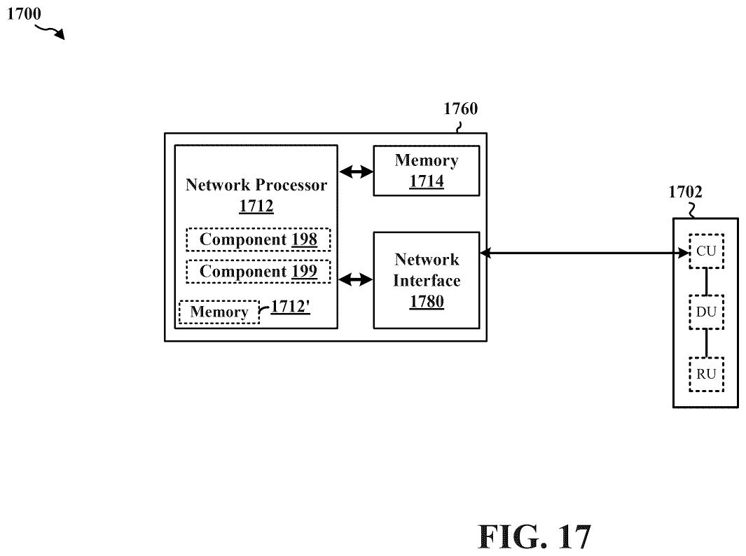

FIG. 17 is a diagram 1700 illustrating an example of a hardware implementation for a network entity 1760. In one example, the network entity 1760 may be within the core network 120. The network entity 1760 may include a network processor 1712. The network processor 1712 may include on-chip memory 1712′. In some aspects, the network entity 1760 may further include additional memory modules 1714. The network entity 1760 communicates via the network interface 1780 directly (e.g., backhaul link) or indirectly (e.g., through a RIC) with the CU 1702. The on-chip memory 1712′ and the additional memory modules 1714 may each be considered a computer-readable medium/memory. Each computer-readable medium/memory may be non-transitory. The processor 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the offset component 198 may be configured to obtain a configuration of a control plane including a set of time offsets. The offset component 198 may also be configured to calculate a corresponding fast Fourier transform (FFT) window for each time offset in the set of time offsets. The offset component 198 may also be configured to receive at least one reference signal (RS) during the corresponding FFT window for each time offset in the set of time offsets. The offset component 198 may also be configured to apply each time offset in the set of time offsets to the corresponding FFT window. The offset component 198 may also be configured to determine a starting point of the corresponding FFT window based on each applied time offset. The offset component 198 may also be configured to select a set of subpanels or a set of transmission-reception (Tx-Rx) streams for the at least one RS based on the configuration of the control plane. The offset component 198 may also be configured to process the at least one RS after the corresponding FFT window for each time offset in the set of time offsets. The offset component 198 may also be configured to transmit the at least one RS based on processing the at least one RS after the corresponding FFT window. The offset component 199 may also be configured to configure a control plane including a set of time offsets. The offset component 199 may also be configured to transmit a configuration of the control plane including the set of time offsets, where each time offset in the set of time offsets is associated with a corresponding fast Fourier transform (FFT) window. The offset component 199 may also be configured to receive at least one reference signal (RS) after the corresponding FFT window for each time offset in the set of time offsets. The offset component 199 may also be configured to process the at least one RS based on receiving the at least one RS after the corresponding FFT window for each time offset in the set of time offsets.

The offset component 198 and offset component 199 may be within the processor 1712. The offset component 198 and offset component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1760 may include a variety of components configured for various functions. In one configuration, the network entity 1760 may include means for obtaining a configuration of a control plane including a set of time offsets. The network entity 1760 may also include means for calculating a corresponding fast Fourier transform (FFT) window for each time offset in the set of time offsets. The network entity 1760 may also include means for receiving at least one reference signal (RS) during the corresponding FFT window for each time offset in the set of time offsets. The network entity 1760 may also include means for applying each time offset in the set of time offsets to the corresponding FFT window. The network entity 1760 may also include means for determining a starting point of the corresponding FFT window based on each applied time offset. The network entity 1760 may also include means for selecting a set of subpanels or a set of transmission-reception (Tx-Rx) streams for the at least one RS based on the configuration of the control plane. The network entity 1760 may also include means for processing the at least one RS after the corresponding FFT window for each time offset in the set of time offsets. The network entity 1760 may also include means for transmitting the at least one RS based on processing the at least one RS after the corresponding FFT window. The network entity 1760 may also include means for configuring a control plane including a set of time offsets. The network entity 1760 may also include means for transmitting a configuration of the control plane including the set of time offsets, where each time offset in the set of time offsets is associated with a corresponding fast Fourier transform (FFT) window. The network entity 1760 may also include means for receiving at least one reference signal (RS) after the corresponding FFT window for each time offset in the set of time offsets. The network entity 1760 may also include means for processing the at least one RS based on receiving the at least one RS after the corresponding FFT window for each time offset in the set of time offsets. The means may be the offset component 199 of the network entity 1760 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is an apparatus for wireless communication at a network entity, including a memory and at least one processor coupled to the memory and, based at least in part on information stored in the memory, the at least one processor is configured to: obtain a configuration of a control plane including a set of time offsets; calculate a corresponding fast Fourier transform (FFT) window for each time offset in the set of time offsets; and receive at least one reference signal (RS) during the corresponding FFT window for each time offset in the set of time offsets.

Aspect 2 is the apparatus of aspect 1, where the at least one processor is further configured to: apply each time offset in the set of time offsets to the corresponding FFT window, where to calculate the corresponding FFT window for each time offset, the at least one processor is configured to: calculate the corresponding FFT window for each applied time offset.

Aspect 3 is the apparatus of any of aspects 1 and 2, where the at least one processor is further configured to: determine a starting point of the corresponding FFT window based on each applied time offset, where to calculate the corresponding FFT window for each time offset, the at least one processor is configured to: calculate the corresponding FFT window for each time offset further based on the starting point of the corresponding FFT window.

Aspect 4 is the apparatus of any of aspects 1 to 3, where the corresponding FFT window for each time offset is associated with at least one message for the control plane.

Aspect 5 is the apparatus of aspect 4, the at least one message for the control plane includes a section extension associated with a time offset structure.

Aspect 6 is the apparatus of any of aspects 4 to 5, where the section extension of the at least one message for the control plane corresponds to at least one of: a plurality of time offset fields, a plurality of values in the time offset structure, or a plurality of time offset parameters.

Aspect 7 is the apparatus of any of aspects 1 to 6, where the at least one processor is further configured to: select a set of subpanels or a set of transmission-reception (Tx-Rx) streams for the at least one RS based on the configuration of the control plane.

Aspect 8 is the apparatus of aspect 7, where to select the set of subpanels or the set of Tx-Rx streams for the at least one RS, the at least one processor is configured to: select the set of subpanels or the set of Tx-Rx streams based on at least one power condition, where the at least one power condition corresponds to a power threshold or a loading threshold of a fronthaul (FH) interface.

Aspect 9 is the apparatus of any of aspects 1 to 8, where the configuration of the control plane includes at least one of: a maximum number of time offset fields, a maximum number of values in a time offset structure, or a maximum number of time offset parameters.

Aspect 10 is the apparatus of any of aspects 1 to 9, where the at least one processor is further configured to: process the at least one RS after the corresponding FFT window for each time offset in the set of time offsets.

Aspect 11 is the apparatus of aspect 10, where the at least one processor is further configured to: transmit the at least one RS based on the at least one processor being configured to process the at least one RS after the corresponding FFT window.

Aspect 12 is the apparatus of any of aspects 10 to 11, where to transmit the at least one RS, the at least one processor is configured to: transmit the at least one RS to a distributed unit (DU) in a radio access network (RAN).

Aspect 13 is the apparatus of any of aspects 1 to 12, where the configuration of the control plane is associated with an adjustment to the set of time offsets.

Aspect 14 is the apparatus of any of aspects 1 to 13, where the configuration of the control plane further includes at least one of: a frame structure, a cyclic prefix (CP) length, a starting physical resource block (PRB) in a set of PRBs, or a number of PRBs in the set of PRBs.

Aspect 15 is the apparatus of any of aspects 1 to 14, where the corresponding FFT window for each time offset in the set of time offsets is associated with an observation window.

Aspect 16 is the apparatus of any of aspects 1 to 15, where the network entity is a radio unit (RU) in a radio access network (RAN), and where to obtain the configuration of the control plane, the at least one processor is configured to: receive the configuration of the control plane from a distributed unit (DU) in the RAN.

Aspect 17 is the apparatus of any of aspects 1 to 16, further including at least one of an antenna or a transceiver coupled to the at least one processor, where to receive the at least one RS during the corresponding FFT window for each time offset in the set of time offsets, the at least one processor is configured to: receive, via at least one of the antenna or the transceiver, the at least one RS during the corresponding FFT window from a user equipment (UE) or a transmission reception point (TRP).

Aspect 18 is an apparatus for wireless communication at a network entity, including a memory and at least one processor coupled to the memory and, based at least in part on information stored in the memory, the at least one processor is configured to: configure a control plane including a set of time offsets; transmit a configuration of the control plane including the set of time offsets, where each time offset in the set of time offsets is associated with a corresponding fast Fourier transform (FFT) window; and receive at least one reference signal (RS) after the corresponding FFT window for each time offset in the set of time offsets.

Aspect 19 is the apparatus of aspect 18, where each time offset in the set of time offsets is configured to be applied to the corresponding FFT window.

Aspect 20 is the apparatus of any of aspects 18 and 19, where a starting point of the corresponding FFT window is based on each applied time offset in the set of time offsets.

Aspect 21 is the apparatus of any of aspects 18 to 20, where the corresponding FFT window for each time offset is associated with at least one message for the control plane.

Aspect 22 is the apparatus of aspect 21, where the at least one message for the control plane includes a section extension associated with a time offset structure, and where the section extension of the at least one message for the control plane corresponds to at least one of: a plurality of time offset fields, a plurality of values in the time offset structure, or a plurality of time offset parameters.

Aspect 23 is the apparatus of aspects 18 to 22, where a set of subpanels or a set of transmission-reception (Tx-Rx) streams for the at least one RS is based on the configuration of the control plane, and where the set of subpanels or the set of Tx-Rx streams for the at least one RS is further based on at least one power condition, where the at least one power condition corresponds to a power threshold or a loading threshold of a fronthaul (FH) interface.

Aspect 24 is the apparatus of any of aspects 18 to 23, where the configuration of the control plane includes at least one of: a maximum number of time offset fields, a maximum number of values in a time offset structure, or a maximum number of time offset parameters.

Aspect 25 is the apparatus of any of aspects 18 to 24, where the at least one processor is further configured to: process the at least one RS based on the at least one processor being configured to receive the at least one RS after the corresponding FFT window for each time offset in the set of time offsets.

Aspect 26 is the apparatus of aspects 18 to 25, where the configuration of the control plane is associated with an adjustment to the set of time offsets, and where the configuration of the control plane further includes at least one of: a frame structure, a cyclic prefix (CP) length, a starting physical resource block (PRB) in a set of PRBs, or a number of PRBs in the set of PRBs.

Aspect 27 is the apparatus of aspects 18 to 26, where the corresponding FFT window for each time offset in the set of time offsets is associated with an observation window.

Aspect 28 is the apparatus of aspects 18 to 27, further including at least one of an antenna or a transceiver coupled to the at least one processor, where the network entity is a distributed unit (DU) in a radio access network (RAN), where to transmit the configuration of the control plane, the at least one processor is configured to: transmit, via at least one of the antenna or the transceiver, the configuration to a radio unit (RU) in the RAN, and where to receive the at least one RS, the at least one processor is configured to: receive the at least one RS from the RU in the RAN.

Aspect 29 is the apparatus of any of aspects 1 to 28, where the apparatus is a wireless communication device, further including at least one of an antenna or a transceiver coupled to the at least one processor.

Aspect 30 is a method of wireless communication for implementing any of aspects 1 to 29.

Aspect 31 is an apparatus for wireless communication including means for implementing any of aspects 1 to 29.

Aspect 32 is a computer-readable medium (e.g., a non-transitory computer-readable medium) storing computer executable code, the code when executed by at least one processor causes the at least one processor to implement any of aspects 1 to 29.

1. An apparatus for wireless communication at a network entity, comprising:
a memory; and
at least one processor coupled to the memory and, based at least in part on first information stored in the memory, the at least one processor is configured to:
obtain a configuration of a control plane including a set of time offsets;
calculate a corresponding fast Fourier transform (FFT) window for each time offset in the set of time offsets; and
receive at least one reference signal (RS) during the corresponding FFT window for each time offset in the set of time offsets.

2. The apparatus of claim 1, wherein the at least one processor is further configured to:
apply each time offset in the set of time offsets to the corresponding FFT window, wherein to calculate the corresponding FFT window for each time offset, the at least one processor is configured to: calculate the corresponding FFT window for each applied time offset.

3. The apparatus of claim 2, wherein the at least one processor is further configured to:
determine a starting point of the corresponding FFT window based on each applied time offset, wherein to calculate the corresponding FFT window for each time offset, the at least one processor is configured to: calculate the corresponding FFT window for each time offset further based on the starting point of the corresponding FFT window.

4. The apparatus of claim 1, wherein the corresponding FFT window for each time offset is associated with at least one message for the control plane.

5. The apparatus of claim 4, wherein the at least one message for the control plane includes a section extension associated with a time offset structure.

6. The apparatus of claim 5, wherein the section extension of the at least one message for the control plane corresponds to at least one of: a plurality of time offset fields, a plurality of values in the time offset structure, or a plurality of time offset parameters.

7. The apparatus of claim 1, wherein the at least one processor is further configured to:
select a set of subpanels or a set of transmission-reception (Tx-Rx) streams for the at least one RS based on the configuration of the control plane.

8. The apparatus of claim 7, wherein to select the set of subpanels or the set of Tx-Rx streams for the at least one RS, the at least one processor is configured to: select the set of subpanels or the set of Tx-Rx streams based on at least one power condition, wherein the at least one power condition corresponds to a power threshold or a loading threshold of a fronthaul (FH) interface.

9. The apparatus of claim 1, wherein the configuration of the control plane includes at least one of: a maximum number of time offset fields, a maximum number of values in a time offset structure, or a maximum number of time offset parameters.

10. The apparatus of claim 1, wherein the at least one processor is further configured to:
process the at least one RS after the corresponding FFT window for each time offset in the set of time offsets.

11. The apparatus of claim 10, wherein the at least one processor is further configured to:
transmit the at least one RS based on the at least one processor being configured to process the at least one RS after the corresponding FFT window.

12. The apparatus of claim 11, wherein to transmit the at least one RS, the at least one processor is configured to: transmit the at least one RS to a distributed unit (DU) in a radio access network (RAN).

13. The apparatus of claim 1, wherein the configuration of the control plane is associated with an adjustment to the set of time offsets.

14. The apparatus of claim 1, wherein the configuration of the control plane further includes at least one of: a frame structure, a cyclic prefix (CP) length, a starting physical resource block (PRB) in a set of PRBs, or a number of PRBs in the set of PRBs.

15. The apparatus of claim 1, wherein the corresponding FFT window for each time offset in the set of time offsets is associated with an observation window.

16. The apparatus of claim 1, wherein the network entity is a radio unit (RU) in a radio access network (RAN), and wherein to obtain the configuration of the control plane, the at least one processor is configured to: receive the configuration of the control plane from a distributed unit (DU) in the RAN.

17. The apparatus of claim 1, further comprising at least one of an antenna or a transceiver coupled to the at least one processor, wherein to receive the at least one RS during the corresponding FFT window for each time offset in the set of time offsets, the at least one processor is configured to: receive, via at least one of the antenna or the transceiver, the at least one RS during the corresponding FFT window from a user equipment (UE) or a transmission reception point (TRP).

18-28. (canceled)

29. A method of wireless communication at a network entity, comprising:
obtaining a configuration of a control plane including a set of time offsets;
calculating a corresponding fast Fourier transform (FFT) window for each time offset in the set of time offsets; and
receiving at least one reference signal (RS) during the corresponding FFT window for each time offset in the set of time offsets.

30. (canceled)
